(19) United States
(12) Patent Application Publication
(10) Pub. No.: US 2023/0084478 A1
(43) Pub. Date: Mar. 16, 2023

(54) PRINTING DEVICE STARTUP LEVEL BASED ON COMPUTED PEN AGE

(71) Applicant: HEWLETT-PACKARD DEVELOPMENT COMPANY, L.P., Spring, TX (US)

(72) Inventors: Huy LE, Corvallis, OR (US); Hwee Yee Ong, Singapore (SG); Kwong Shon Lee, Singapore (SG); Andy Prima Kencana, Singapore (SG); Rachel M. White, Corvallis, OR (US); Qiuling Chen, Singapore (SG); Aik San Ng, Singapore (SG)

(73) Assignee: HEWLETT-PACKARD DEVELOPMENT COMPANY, L.P., Spring, TX (US)

(21) Appl. No.: 17/471,883

(22) Filed: Sep. 10, 2021

(51) Int. Cl. B41J 2/175; B41J 29/393

(52) U.S. Cl. CPC B41J 2/17546; B41J 29/393; B41J 2/17566; B41J 2002/17569

(57) ABSTRACT

A non-limiting example method of printing device startup based on computed pen age includes reading a pen manufacturing date encoded in a pen of a printing device. The method includes computing a pen age for the pen of the printing device based on the pen manufacturing date, and selecting a startup level based on the computed pen age.

### BACKGROUND

Printers are commonplace in both home environments and office environments. Such printers can include laser printers, inkjet printers or other types of printers. Generally, inkjet printers include print heads which deposit ink onto a print medium, such as paper. The print heads may move across the width of the print medium to selectively deposit ink to produce the desired image. Inkjet printers create images from digital files by propelling droplets of ink onto paper or other materials. The droplets are deposited from nozzles in a print head assembly as the print head assembly traverses a print carriage while the paper is advanced.

Inkjet printers create images from digital files by propelling droplets of ink onto paper or other materials. The droplets are deposited from nozzles in a print head assembly as the print head assembly traverses a print carriage while the paper is advanced. Under certain conditions, such as during transport or storage, ink may leak or drool from the printer. Some inkjet printers may include some active mechanism, such as clamps or mechanical valves, for example, to prevent ink from leaking from the print head when the printer is not in operation.

### BRIEF DESCRIPTION OF THE DRAWINGS

FIG. 1 illustrates an example method for printing device startup based on computed pen age, in accordance with the present disclosure.

FIG. 2 illustrates an example apparatus for printing device startup based on computed pen age, in accordance with the present disclosure.

FIG. 3 illustrates a flow diagram of an example method for printing device startup based on computed pen age, in accordance with the present disclosure.

FIG. 4 illustrates an example apparatus for printing device startup based on computed pen age, in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Printing devices can include printers, copiers, fax machines, multifunction devices including additional scanning, copying, and finishing functions, all-in-one devices, or other devices such as pad printers to print images on three dimensional objects and three-dimensional printers (additive manufacturing devices). In general, printing devices apply a print substance often in a subtractive color space or black to a medium via a device component generally referred to as a print head. For example, printing devices that print in color mode may include supplies of subtractive color print substances such as cyan, yellow, magenta, and black or spot colors, and printing devices that print in greyscale or monochromatic mode can include supplies of print substances such as black or a spot color. A medium can include various types of print media, such as plain paper, photo paper, polymeric substrates and can include any suitable object or materials to which a print substance from a printing device are applied including materials, such as powdered build materials, for forming three-dimensional articles. Print substances, such as printing agents, marking agents, and colorants, can include toner, liquid inks, or other suitable marking material that in some examples may be mixed with other print substances such as fusing agents, detailing agents, or other materials and can be applied to the medium. Printing devices can include a refillable print substance reservoir, to hold a print substance.

As used herein, the term “print substance” refers to or includes any substance that may be received by a printing device in order to form a two-dimensional (2D) image or three-dimensional (3D) object. Examples of print substances may include, without limitations, an ink of any type or color or an additive manufacturing fabrication agent. Still further, as used herein, the term “fabrication agent” refers to or includes any number of agents that are deposited and includes for example a fusing agent, an inhibitor agent, a binding agent, a coloring agent, and/or a material delivery agent. A material delivery agent refers to or includes a liquid carrier that includes suspended particles of material used in the additive manufacturing process.

Printing devices with a continuous print substance supply system, such as continuous ink supply systems, include print substance reservoirs to store print substance for use with the print head. The print substance reservoirs may be filled with print substance from a print substance supply at the discretion of the user. Users can determine an amount of print substance to provide to the print substance reservoir and a frequency to provide the print substance to the print substance reservoir. In general, the print substance reservoir includes an upper fill level to indicate when the print substance reservoir is full of print substance and a lower fill level to indicate when the print substance reservoir is sufficiently devoid of print substance, such as empty. Print substance can be provided to the print substance reservoir, such as when the print substance reservoir is sufficiently devoid of print substance, up to the upper fill level.

Printing devices employ level sensors to determine the level, such as height or amount, of the print substance in the print substance reservoir. Based on information obtained from the level sensor, printing devices can determine information such as how much print substance remains in the print substance reservoir and how much print substance has been added to the print substance reservoir when filled. Level sensors deployed in the print substance reservoir that contact the print substance can often accurately detect the amount of print substance, but the sensor structures can introduce sources of leaks, contamination, and corrosion into the print substance reservoir. Level sensors have been developed to continuously detect the amount of print substance from outside the print substance reservoir by measuring the capacitance of the interior of the print substance reservoir. Such sensors are affected by environmental changes such as temperature and humidity that degrade accuracy.

Startup routine at new pen installation helps to condition pens to ‘good working state’ to deliver satisfactory print quality experience. These startup routines are usually non-adaptive, involving moving a fixed amount of ink through pen to purge or flush internal chambers. However, the startup purge routine may not be sufficient to cover ink variation arising from water depletion, pigment settling and ink-foam interaction over extended shelf life or pen age. This could result in bad print quality experience at new pen installation, thereby causing high warranty rates. Purging (or spitting large amount ink) during pen startup helps to refresh ink at nozzles, thereby reducing defect severity.

A non-limiting example method of printing device startup based on computed pen age includes reading a pen manufacturing date encoded in a pen of a printing device. The method includes computing a pen age for the pen of the printing device based on the pen manufacturing date, and selecting a startup level based on the computed pen age.

An example apparatus for printing device startup based on computed pen age may include a non-transitory computer-readable medium storing instructions that when executed cause a processor of a printing device to read a pen manufacturing date encoded in a pen of the printing device. The non-transitory computer-readable medium may store instructions to compute a pen age based on a comparison of the pen manufacturing date and real time clock information, and read information encoded in the pen to determine if the pen is new or used. Moreover, the non-transitory computer-readable medium may store instructions to select a startup level based on the computed pen age and based on the determination if the pen is new or used.

An example apparatus for printing device startup level based on computed pen age may include a non-transitory computer-readable medium storing instructions that when executed cause a processor to receive a pen manufacturing date encoded in a pen of a printing device. The non-transitory computer-readable medium may store instructions to compute a pen age for the pen of the printing device based on a comparison of the pen manufacturing date and an install date for the pen. The non-transitory computer-readable medium may store instructions to select a startup level based on the computed pen age, and communicate the selected startup level for the pen to the printing device to purge device print substance from the pen in an amount associated with the selected startup level.

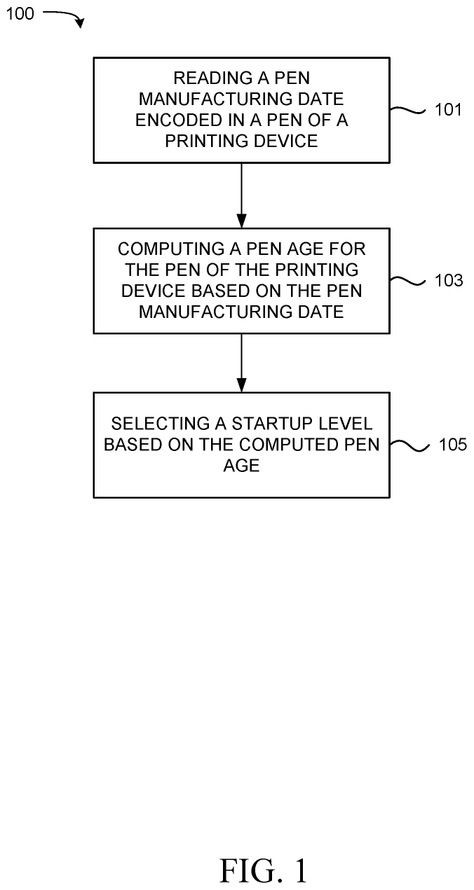

Turning now to the Figures, FIG. 1 illustrates an example method 100 for printing device startup based on computed pen age, in accordance with the present disclosure. At 101, the method 100 includes reading a pen manufacturing date encoded in a pen of a printing device. In some examples, the printing device reads the manufacturing date encoded in the pen, however, examples are not so limited. For instance, in some examples, the printing device may communicate with a cloud-based solution, such as a network connected computing device, which retrieves a manufacturing date of the pen. In various examples, a pen includes a print head that is controlled to selectively eject print substance onto a printing surface to form images and characters. The pen may include pressure regulating mechanisms to maintain the print substance at a particular pressure for use by the print head.

At 103, the method 100 includes computing a pen age for the pen of the printing device based on the pen manufacturing date. In some examples, the printing device computes the pen age, however, examples are not so limited. For instance, in some examples, the printing device may communicate with a cloud-based solution, such as a network connected computing device, which computes the pen age. In some examples, the pen age may be impacted by environmental factors in a location where the printing device is located. For instance, temperature, humidity, light exposure, altitude, and other environmental factors may contribute to altering the print quality of print substances. Print substances stored in particular environmental conditions may clump, dry out, or experience other changes that influence an amount of print substance to be purged during startup to improve print quality following startup.

At 105, the method 100 includes selecting a startup level based on the computed pen age. As used herein, a startup level refers to or includes an operation performed by the printing device to purge a volume of print substance from the pen before the pen is ready to be used. The startup level may be associated with a volume of print substance to be purged from the pen when the pen is installed in the printing device, and an amount of time associated with the respective startup level. Each respective startup level may be associated with a different respective age of pen. For instance, a pen aged less than or equal to 6 months from the date of manufacture may be associated with a 50% pen age, a level 1 startup, and a 5 cubic centimeter (cc) purge volume. The level 1 startup may be associated with a 10 minute (+/−1 minute) startup duration. A pen aged 7 months to 9 months from the date of manufacture may be associated with a 28% pen age, a level 2 startup, and a 7 cc purge volume. The level 2 startup may be associated with a 14 minute (+/−1 minute) startup duration. A pen aged 10 months to 12 months from the date of manufacture may be associated with a 12% pen age, a level 3 startup, and a 9 cc purge volume. The level 3 startup may be associated with an 18 minute (+/−1 minute) startup duration. A pen aged 13 months to 15 months from the date of manufacture may be associated with a 10% pen age, a level 4 startup, and a 12 cc purge volume. The level 4 startup may be associated with a 22 minute (+/−1 minute) startup duration. A pen aged greater than 15 months from the date of manufacture may be associated with a 28% pen age, a level 5 startup, and a 15 cc purge volume. The level 5 startup may be associated with a 29 minute (+/−1 minute) startup duration. The age ranges, number of levels, and purge volume for each startup level are provided for illustration purposes, and any age range, numbers of levels, purge volumes, and startup durations are contemplated in accordance with the present disclosure. As such, selecting the startup level may include selecting a startup level among a plurality of startup levels, wherein each startup level is associated with a different respective volume of print substance. The selected volume of print substance may be purged from the print head during startup to improve print quality following startup of the pen.

In some examples, the method 100 includes obtaining real time clock information from the printing device, and computing the pen age based on a comparison of the real time clock information and pen manufacturing date. For instance, a real time clock maintained by the printing device may be used to compare the pen manufacturing date. Examples are not so limited, and the method 100 may include obtaining time and/or date information from a source external to the printing device. For instance, the printing device may communicate with a network-based computing device to determine the date and/or time for purposes of computing the pen age. Regardless of the source of the clock information, the present date and/or time may be compared to the manufacturing date of the pen to determine the pen age.

In some examples, the method 100 includes identifying environmental conditions of a location of the printing device, and selecting the startup level based on the identified environmental conditions. For example, in environments that are particularly humid, or particular arid, a different amount of print substance may be purged from the pen. A pen that is aged 5 months may be initially associated with a level 1 startup based on the computed age from the date of manufacture. However, the pen may be stored in a dry and hot environment, and because of the storage conditions of the pen the pen age may be computed at 7-9 months and associated with a level 2 startup. Again, the relative age of the pen is provided for illustration purposes. The amount to which a pen is aged based on various environmental conditions may vary, and any environmental conditions and relative aging of pens, print substances, and/or printing devices are contemplated in accordance with the present disclosure.

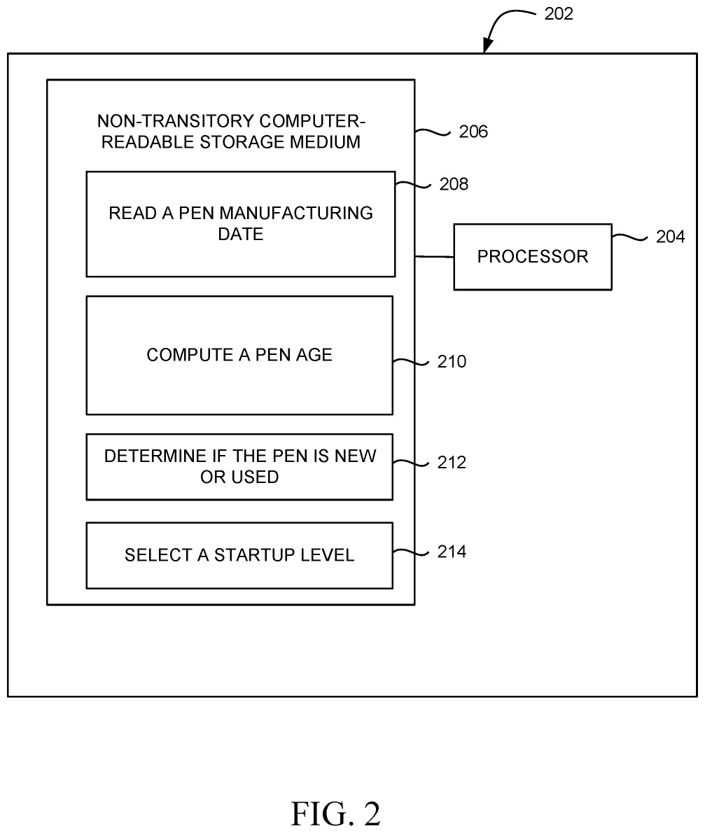

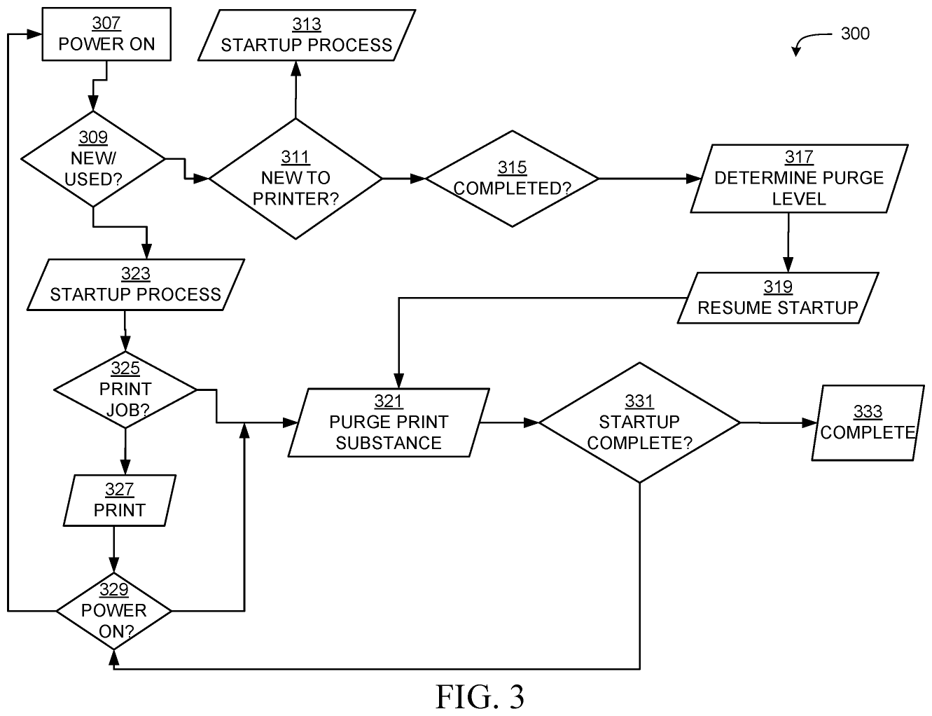

FIG. 2 illustrates an example apparatus 202 for printing device startup based on computed pen age, in accordance with the present disclosure. As illustrated in FIG. 2, the apparatus 202 may include a processor 204, and a computer-readable storage medium 206. The apparatus 202 may perform the method 100 illustrated in FIG. 1, as well as the method 300 illustrated in FIG. 3.

The processor 204 may be a central processing unit (CPU), a semiconductor-based microprocessor, and/or other hardware device suitable to control operations of the apparatus 202. Computer-readable storage medium 206 may be an electronic, magnetic, optical, or other physical storage device that contains or stores executable instructions. Thus, computer-readable storage medium 206 may be, for example, Random Access Memory (RAM), an Electrically Erasable Programmable Read-Only Memory (EEPROM), a storage device, an optical disc, etc. In some examples, the computer-readable storage medium 206 may be a non-transitory storage medium, where the term ‘non-transitory’ does not encompass transitory propagating signals. As described in detail below, the computer-readable storage medium 206 may be encoded with a series of executable instructions 208-214.

The computer-readable storage medium 206 may be encoded with instructions 208 that when executed, cause the processor 204 to read a pen manufacturing date encoded in a pen of the printing device. As described with regards to FIG. 1, the printing device (e.g., apparatus 202) may read the pen manufacturing date encoded in the pen. Examples are not so limited, and a network-connected computing device coupled to the apparatus 202 may read the pen manufacturing date encoded in the pen.

The computer-readable storage medium 206 may be encoded with instructions 210 that when executed, cause the processor 204 to compute a pen age based on a comparison of the pen manufacturing date and real time clock information. The pen age may be computed by subtracting the pen manufacturing date from the real time clock information. As described herein, the pen age may also be computed based in part on an environmental factor or a plurality of environmental factors associated with a location in which the printing device is located.

The computer-readable storage medium 206 may be encoded with instructions 212 that when executed, cause the processor 204 to read information encoded in the pen to determine if the pen is new or used. As discussed with regards to FIG. 3, if a startup process is initiated but not completed, the startup may resume with a different purge volume.

The computer-readable storage medium 206 may be encoded with instructions 214 that when executed, cause the processor 204 to select a startup level based on the computed pen age and based on the determination if the pen is new or used. In some examples, the instructions 214 to select the startup level includes instructions that when executed cause the processor 204 to determine that a previous startup process was interrupted, compute a duration of the interruption of the previous startup process, and select the startup level based on the computed pen age and the computed duration of the interruption. As described with regards to FIG. 1, each startup level among a plurality of startup levels includes a respective print substance volume to purge from the pen.

In some examples, the instructions 214 to select a startup level include instructions to communicate to a network-connected computing device, the computed pen age and determination if the pen is new or used, and receive from the network-connected computing device, the selected startup level. For instance, the startup process may be managed and/or initiated by another computing device such as by a computing device in a cloud environment.

FIG. 3 illustrates a flow diagram of an example method 300 for printing device startup based on computed pen age, in accordance with the present disclosure. The method begins at 307, when the printer is tuned on. At 309, it is determined if the pen is new or used. If the pen is used, the method continues at 311. If the pen is new, the method continues at 323.

At 311, the method includes determining if the pen is new to that printer. If it is, then the method continues at 313 with pen startup as described with regards to FIG. 1. If the pen is not new to the printer, the method continues at 315 with determining if the startup process was completed. If it was not, then the method continues at 317 with determining the purge level. To compute the purge level (e.g., the purge volume) the new pen age is determined by subtracting the manufacturing date from the real time clock, and the new purge level is set by the new pen age. The method continues at 319 with resuming of the startup process, including resuming purge of the print substance. The new purge volume at step 319 may be determined by subtracting the purged volume from the new level volume to obtain the new purge volume. The method continues at 321 with purging of the print substance.

If at 309, it is determined that the pen is new, the method continues to 323. At 323, the method includes initiating the pen startup process. The method continues to 325 where it is determined if there is a print job pending. If no, the method continues to 321 (i.e., purging). If a print job is pending, then the method continues to 327. At 327, the method includes printing using a printing service, and continues to 329. At 329, the method includes determining if the power is on. If it is on, then the method continues to 321 with purging the printing substance. If at 329 it is determined that the power is not on, then the method continues to 307 with power on of the printer.

At 321, the method includes purging the print substance. The amount of print substance purged may be determined based on the age of the pen, as discussed herein. The method continues at 331 by determining if the startup is completed. If at 331 it is determined that the startup is not completed, then the method continues at 329 with determining if the power is on and continuing the method. If at 331 it is determined that the startup was complete then the method ends at 333 with completion of the pen startup.

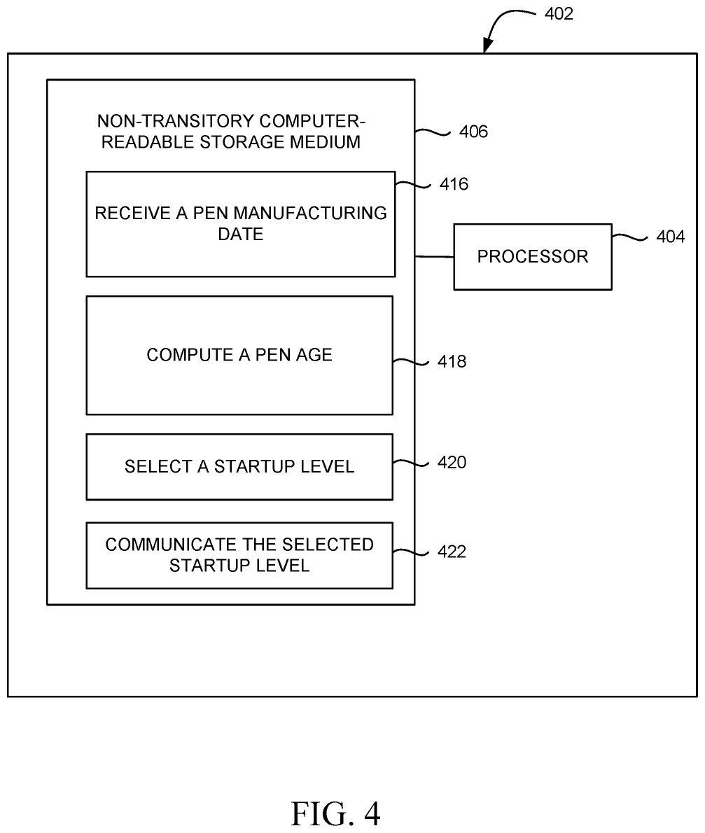

FIG. 4 illustrates an example apparatus 402 for printing device startup based on computed pen age, in accordance with the present disclosure. In general, the apparatus 402 shown in FIG. 4 may include various components that are the same and/or substantially similar to the apparatus 202 shown in FIG. 2, which was described in greater detail above. As such, for brevity and ease of description, various details relating to certain components in the apparatus 402 shown in FIG. 4 may be omitted herein to the extent that the same or similar details have already been provided above in relation to the apparatus 202 illustrated in FIG. 2.

As illustrated FIG. 4, the non-transitory computer-readable medium 406 may store instructions 416 that when executed cause the processor 404 to receive a pen manufacturing date encoded in a pen of a printing device. For instance, in examples in which pen startup is performed by a network-connected computing device, such as in a cloud based system, the computing device (e.g., apparatus 402 in FIG. 4) may receive the pen manufactured date from the pen. Examples are not so limited, and the computing device performing the pen startup (e.g., apparatus 402 in FIG. 4) may be the printer into which the pen has been inserted. In such examples, the printing device (e.g., apparatus 402) may receive and/or retrieve the pen manufacturing date from the pen.

As illustrated, the non-transitory computer-readable medium 406 may store instructions 418 that when executed cause the processor 404 to compute a pen age for the pen of the printing device based on a comparison of the pen manufacturing date and an install date for the pen. As described herein, the pen age may be computed locally by the printer itself, and/or by a network-connected computing device such as in a cloud based system.

The non-transitory computer-readable medium 406 may store instructions 420 that when executed cause the processor 404 to select a startup level based on the computed pen age. In various examples, the instructions to select the startup level include instructions to select a startup level among a plurality of startup levels, wherein each startup level is associated with a different respective volume of print substance to be purged from the pen. The startup level may be selected based on the age of the pen, as well as environmental factors of a location where the printing device is located. As such, the non-transitory computer-readable medium 406 may store instructions that when executed cause the processor 404 to, determine a geographic location of the printing device, and select the startup level based on the computed pen age and the determined geographic location. Similarly, the non-transitory computer-readable medium 406 may store instructions that when executed cause the processor 404 to determine an environmental factor of a location of the printing device, and select the startup level based on the computed pen age and the determined environmental factor.

In some examples, the non-transitory computer-readable medium 406 may store instructions 422 that when executed cause the processor 404 to, communicate the selected startup level for the pen to the printing device to purge the print substance from the pen in an amount associated with the selected startup level.

In some examples, the non-transitory computer-readable medium 406 may store instructions that when executed cause the processor 404 to determine that a previous startup process was interrupted, compute a duration of the interruption of the previous startup process, and select the startup level based on the computed pen age and the computed duration of the interruption. In such examples, a previously incomplete setup may be continued.

In some examples, the non-transitory computer-readable medium 406 may store instructions that when executed cause the processor 404 to read information encoded in the pen to determine if the pen is new or used, and select a startup level based on the computed pen age and based on the determination if the pen is new or used.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
reading a pen manufacturing date encoded in a pen of a printing device;
computing a pen age for the pen of the printing device based on the pen manufacturing date; and
selecting a startup level based on the computed pen age.

2. The method of claim 1, further including obtaining real time clock information from the printing device, and computing the pen age based on a comparison of the real time clock information and pen manufacturing date.

3. The method of claim 1, further including identifying environmental conditions of a location of the printing device, and selecting the startup level based on the identified environmental conditions.

4. The method of claim 1, wherein selecting the startup level includes selecting a startup level among a plurality of startup levels, wherein each startup level is associated with a different respective volume of print substance to be purged during startup.

5. The method of claim 1, further including determining if the pen of the printing device is new or used by reading information stored in the pen.

6. A non-transitory computer-readable medium storing instructions that when executed cause a processor of a printing device to:
read a pen manufacturing date encoded in a pen of the printing device;
compute a pen age based on a comparison of the pen manufacturing date and real time clock information;
read information encoded in the pen to determine if the pen is new or used; and
select a startup level based on the computed pen age and based on the determination if the pen is new or used.

7. The medium of claim 6, wherein the instructions to select the startup level include instructions that when executed cause the processor to:
determine that a previous startup process was interrupted;
compute a duration of the interruption of the previous startup process; and
select the startup level based on the computed pen age and the computed duration of the interruption.

8. The medium of claim 7, wherein each startup level among a plurality of startup levels includes a respective print substance volume to purge from the pen of the printing device.

9. The medium of claim 6, wherein the instructions to select a startup level include instructions to:
communicate to a network-connected computing device, the computed pen age and determination if the pen is new or used; and
receive from the network-connected computing device, the selected startup level.

10. A non-transitory computer-readable medium storing instructions that when executed cause a processor to:
receive a pen manufacturing date encoded in a pen of a printing device;
compute a pen age for the pen of the printing device based on a comparison of the pen manufacturing date and an install date for the pen;
select a startup level based on the computed pen age; and
communicate the selected startup level for the pen to the printing device to purge a print substance from the pen in an amount associated with the selected startup level.

11. The medium of claim 10, further including instructions that when executed cause the processor to determine a geographic location of the printing device, and select the startup level based on the computed pen age and the determined geographic location.

12. The medium of claim 10, further including instructions that when executed cause the processor to determine an environmental factor of a location of the printing device, and select the startup level based on the computed pen age and the determined environmental factor.

13. The medium of claim 10, further including instructions that when executed cause the processor to read information encoded in the pen to determine if the pen is new or used, and select a startup level based on the computed pen age and based on the determination if the pen is new or used.

14. The medium of claim 10, wherein the instructions to select the startup level include instructions that when executed cause the processor to:
determine that a previous startup process was interrupted;
compute a duration of the interruption of the previous startup process; and
select the startup level based on the computed pen age and the computed duration of the interruption.

15. The medium of claim 10, wherein the instructions to selecting the startup level includes selecting a startup level among a plurality of startup levels, wherein each startup level is associated with a different respective volume of print substance to be purged.
